(19) United States
(12) Patent Application Publication
(10) Pub. No.: US 2012/0011314 A1
(43) Pub. Date: Jan. 12, 2012

(54) STORAGE SYSTEM WITH REDUCED ENERGY CONSUMPTION AND METHOD OF OPERATING THEREOF

(75) Inventors: Yechiel YOCHAI, D.N. Menashe (IL); Julian SATRAN, Haifa (IL); Efraim ZEIDNER, Haifa (IL)

(73) Assignee: INFINIDAT LTD., HERZLIYA (IL)

(21) Appl. No.: 13/174,120

(22) Filed: Jun. 30, 2011

Related U.S. Application Data
(60) Provisional application No. 61/391,657, filed on Oct. 10, 2010.
(60) Provisional application No. 61/360,622, filed on Jul. 1, 2010.

(51) Int. Cl. G06F 12/08; G06F 12/16

(52) U.S. Cl. 711/113; 711/114; 711/E12.002; 711/E12.103; 711/E12.019

(57) ABSTRACT

There are provided a storage system with reduced energy consumption and a method of operating thereof. The method comprises caching in the cache memory a plurality of data portions corresponding to one or more incoming write requests, to yield cached data portions; consolidating the cached data portions characterized by a given level of expected I/O activity addressed thereto into a consolidated write request; and, responsive to a destage event, enabling writing the consolidated write request to one or more disk drives dedicated to accommodate data portions characterized by said given level of expected I/O activity addressed thereto. The cached data portions consolidated into the consolidated write request can be characterized by expected low frequency of I/O activity, and the respective one or more dedicated disk drives can be configured to operate in low-powered state unless activated.

### CROSS-REFERENCES TO RELATED APPLICATIONS

This application relates to and claims priority from U.S. Provisional Patent Application No. 61/360,622 filed on Jul. 1, 2010 and U.S. Provisional Patent Application No. 61/391,657 filed on Oct. 10, 2010 incorporated herein by reference in their entirety.

### FIELD OF THE INVENTION

The present invention relates generally to mass data storage systems and, particularly, mass storage systems with reduced energy consumption and mrthods of operating thereof.

### BACKGROUND OF THE INVENTION

One of current trends of development in the storage industry relates to methods and strategies for reduced energy consumption. Data centers may nowadays comprise dozens of storage systems, each comprising hundreds of disk drives. Clearly, most of the data stored in these systems is not in use for long periods of time, and hence most of the disks are likely to contain data that is not accessed for long periods of time. Power is unnecessarily spent in keeping all these disks spinning and, moreover, in cooling the data centers. Thus, efforts are now being invested in reducing energy-related spending in storage systems. Moreover, regulations are increasingly enforced in many countries, forcing data centers to adopt “green” technologies for its servers and storage systems.

The problems of reduced energy consumption in mass data storage systems have been recognized in the Contemporary Art and various systems have been developed to provide a solution as, for example:

US Patent Application No. 2006/0107099 (Pinheiro et al) discloses a redundant storage system comprising: a plurality of storage disks divided into a first subset, wherein all of the plurality of storage disks are dynamically assigned between the first and second subset based on redundancy requirements and system load; a module which diverts read requests to the first subset of storage disks in the redundant storage system, so that the second subset of storage disks in the redundant storage system can transition to a lower power mode until a second subset of storage disks is needed to satisfy a write request; a detection module which detects if the system load in the redundant storage system is high and detects if the system load in the redundant storage system is low; and a module which, if the system load is high, adds one or more storage disks from the second subset to the first subset of storage disks in the redundant storage system so as to handle the system load and if the system load is low, adds one or more storage disks from the first subset to the second subset.

US Patent application No. 2009/129193 (Joshi et al.) discloses an energy efficient storage device using per-element selectable power supply voltages. The storage device is partitioned into multiple elements, which may be sub-arrays, rows, columns or individual storage cells. Each element has a corresponding virtual power supply rail that is provided with a selectable power supply voltage. The power supply voltage provided to the virtual power supply rail for an element is set to the minimum power supply voltage unless a higher power supply voltage is required for the element to meet performance requirements. A control cell may be provided within each element that provides a control signal that selects the power supply voltage supplied to the corresponding virtual power supply rail. The state of the cell may be set via a fuse or mask, or values may be loaded into the control cells at initialization of the storage device.

US Patent application No. 2009/249001 (Narayananet al.) discloses storage systems which use write off-loading. When a request to store some data in a particular storage location is received, if the particular storage location is unavailable, the data is stored in an alternative location. In an embodiment, the particular storage location may be unavailable because it is powered down or because it is overloaded. The data stored in the alternative location may be subsequently recovered and written to the particular storage location once it becomes available.

US Patent application No. 2010/027147 (Subramaniar et al.) discloses a low power consumption storage array. Read and write cycles are separated so that a multiple disk array can be spun down during periods when there are no write requests. Cooling fans are operated with a pulse-width modulated signal in response to a cooling demand to further reduce energy consumption.

### SUMMARY OF THE INVENTION

In accordance with certain aspects of the presently disclosed subject matter, there is provided a method of operating a storage system comprising a control layer configured to interface with one or more clients and to present to said clients a plurality of logical volumes, said control layer comprising a cache memory and is further operatively coupled to a physical storage space comprising a plurality of disk drives. The method comprises caching in the cache memory a plurality of data portions corresponding to one or more incoming write requests, to yield cached data portions; consolidating the cached data portions characterized by a given level of expected I/O activity addressed thereto into a consolidated write request; and, responsive to a destage event, enabling writing the consolidated write request to one or more disk drives dedicated to accommodate data portions characterized by said given level of expected I/O activity addressed thereto.

The cached data portions consolidated into the consolidated write request can be characterized by expected low frequency of I/O activity, and the respective one or more dedicated disk drives can be configured to operate in low-powered state unless activated. The destage event can be related to an activation of a disk drive operating in low-powered state.

In accordance with further aspects of the presently disclosed subject matter, a cached data portion can be characterized by a given level of expected I/O activity if a statistical access pattern characterizing said cached data portion is similar to a predefined reference-frequency access pattern characterizing said given level of expected I/O activity. The method can further comprise collecting I/O statistics from statistical segments obtained by dividing the logical volumes into parts with predefined size, and characterizing all data portions within a given statistical segment by the same statistical access pattern defined in accordance with I/O statistic collected from the given statistical segment.

Alternatively or additionally, a cached data portion can be characterized by a given level of expected I/O activity if a distance between an activity vector characterizing said cached data portion and a reference-frequency activity vector characterizing said given level of expected I/O activity matches a similarity criterion. The method can further comprise collecting I/O statistics from statistical segments obtained by dividing the logical volumes into parts with predefined size, and characterizing all data portions within a given statistical segment by the same activity vector defined in accordance with I/O statistics collected from the given statistical segment. I/O statistics for the given statistical segment can be collected over a plurality of cycles of fixed counted length, and the activity vector can be characterized by at least one value obtained during a current cycle and by at least one value related to I/O statistics collected during at least one of the previous cycles.

In accordance with other aspects of the presently disclosed subject matter, there is provided a storage system comprising a physical storage space comprising a plurality of disk drives and operatively coupled to a control layer configured to interface with one or more clients and to present to said clients a plurality of logical volumes, wherein one or more disk drives are configured as dedicated to accommodate data portions characterized by a given level of expected I/O activity, and wherein said control layer comprises a cache memory and further operable: to cache in the cache memory a plurality of data portions corresponding to one or more incoming write requests, to yield cached data portions; to consolidate the cached data portions characterized by said given level of expected I/O activity addressed thereto into a consolidated write request; and, responsive to a destage event, to enable writing the consolidated write request to said one or more disk drives dedicated to accommodate data portions characterized by said given level of expected I/O activity.

The control layer can be further operable to identify a cached data portion characterized by a given level of expected I/O activity in accordance with similarity between a statistical access pattern characterizing said cached data portion and a predefined reference-frequency access pattern characterizing said given level of expected I/O activity. The control layer can be further operable to collect I/O statistics from statistical segments obtained by dividing the logical volumes into parts with predefined size, wherein all data portions within a given statistical segment are characterized by the same statistical access pattern defined in accordance with I/O statistic collected from the given statistical segment.

Alternatively or additionally, the control layer can be further operable to identify a cached data portion characterized by a given level of expected I/O activity in accordance with a distance between an activity vector characterizing said cached data portion and a reference-frequency activity vector characterizing said given level of expected I/O activity. The control layer can be further operable to collect I/O statistics from statistical segments obtained by dividing the logical volumes into parts with predefined size, wherein all data portions within a given statistical segment are characterized by the same activity vector defined in accordance with I/O statistic collected from the given statistical segment.

In accordance with further aspects of the presently disclosed subject matter, the physical storage space can be further configured as a concatenation of a plurality of RAID Groups, each RAID group comprising N+P RAID group members, and the consolidated write request can comprise N cached data portions characterized by a given level of expected I/O activity and P respective parity portions, thereby constituting a destage stripe corresponding to a RAID group. The members of a RAID group can be distributed over the disk drives in a manner enabling accommodating the destage stripes characterized by the same level of expected I/O activity on one or more disk drives dedicated to accommodate destage stripes characterized by said given level of expected I/O activity. The cached data portions consolidated into the destage stripe can be characterized by expected low frequency of I/O activity, and the respective one or more dedicated disk drives can be configured to operate in low-powered state unless activated.

In accordance with further aspects of the presently disclosed subject matter, the control layer can further comprises a first virtual layer operable to represent the cached data portions with the help of virtual unit addresses corresponding to respective logical addresses, and a second virtual layer operable to represent the cached data portions with the help of virtual disk addresses (VDAs) substantially statically mapped into addresses in the physical storage space, and wherein: the second virtual layer is configured as a concatenation of representations of the RAID groups; the control layer is operable to generate the destage stripe with the help of translating virtual unit addresses characterizing data portions in the stripe into sequential virtual disk addresses, so that the data portions in the destage stripe become contiguously represented in the second virtual layer; and the control layer is further operable to translate the sequential virtual disk addresses into physical storage addresses of the respective RAID group statically mapped to second virtual layer, thereby enabling writing the destage stripe to one or more dedicated disk drives.

The control layer can further comprise a VDA allocator configured to select a RAID Group matching a predefined criteria; to select the address of the next available free stripe within the selected RAID Group; and to allocate VDA addresses corresponding to this available stripe.

### BRIEF DESCRIPTION OF THE DRAWINGS

In order to understand the invention and to see how it can be carried out in practice, embodiments will now be described, by way of non-limiting example only, with reference to the accompanying drawings, in which:

FIG. 1 illustrates a generalized functional block diagram of a mass storage system where the presently disclosed subject matter can be implemented;

FIG. 2 illustrates a schematic diagram of storage space configured in RAID groups as known in the art;

FIG. 3 illustrates a generalized flow-chart of operating the storage system in accordance with certain embodiments of the presently disclosed subject matter;

FIG. 4 illustrates a generalized flow-chart of generating a consolidated write request in accordance with certain embodiments of the presently disclosed subject matter;

FIG. 5 illustrates a schematic diagram of an activity vector in accordance with certain embodiments of the presently disclosed subject matter;

FIG. 6 illustrates a generalized flow-chart of an exemplified embodiment of generating a consolidated write request in accordance with the presently disclosed subject matter;

FIG. 7 illustrates a generalized flow-chart of an exemplified embodiment of operating the storage system in energy consumption mode in accordance with the presently disclosed subject matter;

FIG. 8 illustrates a schematic functional diagram of the control layer where the presently disclosed subject matter can be implemented; and

FIG. 9 illustrates a schematic diagram of generating a consolidated write request in accordance with certain embodiments of the presently disclosed subject matter.

### DETAILED DESCRIPTION OF EMBODIMENTS

In the following detailed description, numerous specific details are set forth in order to provide a thorough understanding of the invention. However, it will be understood by those skilled in the art that the present invention can be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “generating”, “activating”, “translating”, “writing”, “selecting”, “allocating”, “storing”, “managing” or the like, refer to the action and/or processes of a computer that manipulate and/or transform data into other data, said data represented as physical, such as electronic, quantities and/or said data representing the physical objects. The term “computer” should be expansively construed to cover any kind of electronic system with data processing capabilities, including, by way of non-limiting example, storage system and parts thereof disclosed in the present applications.

The operations in accordance with the teachings herein can be performed by a computer specially constructed for the desired purposes or by a general-purpose computer specially configured for the desired purpose by a computer program stored in a computer readable storage medium.

Embodiments of the present invention are not described with reference to any particular programming language. It will be appreciated that a variety of programming languages can be used to implement the teachings of the inventions as described herein.

The references cited in the background teach many principles of operating a storage system that are applicable to the presently disclosed subject matter. Therefore the full contents of these publications are incorporated by reference herein where appropriate for appropriate teachings of additional or alternative details, features and/or technical background.

The term “criterion” used in this patent specification should be expansively construed to include any compound criterion, including, for example, several criteria and/or their logical combinations.

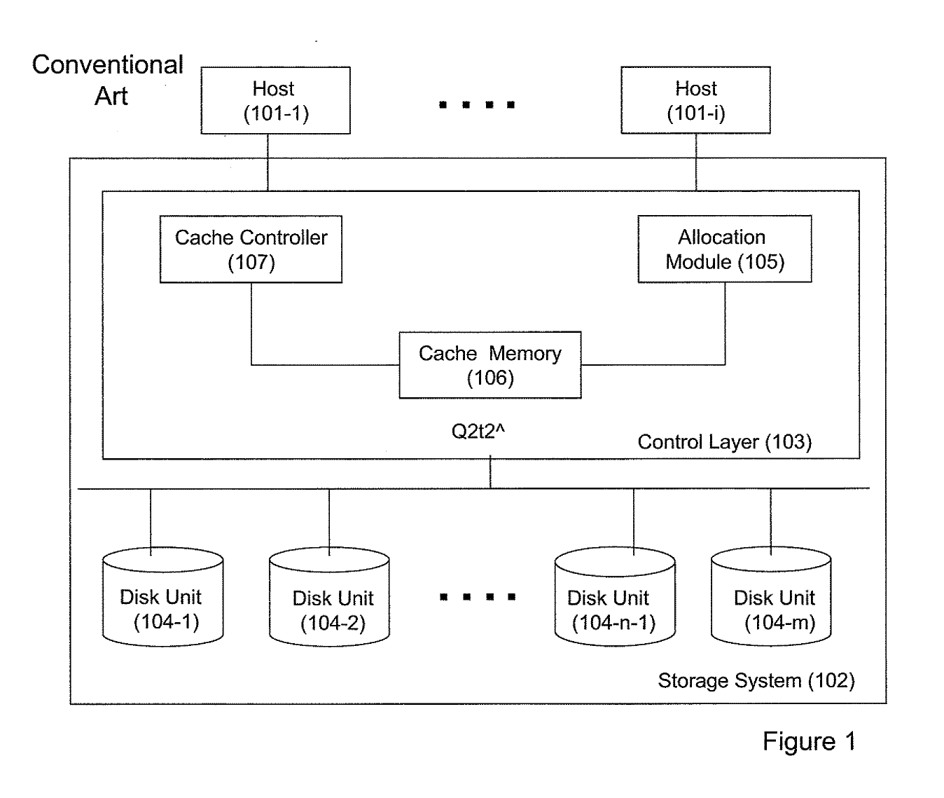

Bearing this in mind, attention is drawn to FIG. 1 illustrating an exemplary storage system as known in the art.

The plurality of host computers (workstations, application servers, etc.) illustrated as 101-1-101-n share common storage means provided by a storage system 102. The storage system comprises a plurality of data storage devices 104-1-104-m constituting a physical storage space optionally distributed over one or more storage nodes and a storage control layer 103 comprising one or more appropriate storage control devices operatively coupled to the plurality of host computers and the plurality of storage devices, wherein the storage control layer is operable to control interface operations (including I/O operations) there between. The storage control layer is further operable to handle a virtual representation of physical storage space and to facilitate necessary mapping between the physical storage space and its virtual representation. The virtualization functions can be provided in hardware, software, firmware or any suitable combination thereof. Optionally, the functions of the control layer can be fully or partly integrated with one or more host computers and/or storage devices and/or with one or more communication devices enabling communication between the hosts and the storage devices. Optionally, a format of logical representation provided by the control layer can differ depending on interfacing applications.

The physical storage space can comprise any appropriate permanent storage medium and include, by way of non-limiting example, one or more disk drives and/or one or more disk units (DUs), comprising several disk drives. The storage control layer and the storage devices can communicate with the host computers and within the storage system in accordance with any appropriate storage protocol.

Stored data can be logically represented to a client in terms of logical objects. Depending on storage protocol, the logical objects can be logical volumes, data files, image files, etc. For purpose of illustration only, the following description is provided with respect to logical objects represented by logical volumes. Those skilled in the art will readily appreciate that the teachings of the present invention are applicable in a similar manner to other logical objects.

A logical volume or logical unit (LU) is a virtual entity logically presented to a client as a single virtual storage device. The logical volume represents a plurality of data blocks characterized by successive Logical Block Addresses (LBA) ranging from 0 to a number LUK. Different LUs can comprise different numbers of data blocks, while the data blocks are typically of equal size (e.g. 512 bytes). Blocks with successive LBAs can be grouped into portions that act as basic units for data handling and organization within the system. Thus, for instance, whenever space has to be allocated on a disk or on a memory component in order to store data, this allocation can be done in terms of data portions also referred to hereinafter as “allocation units”. Data portions are typically of equal size throughout the system (by way of non-limiting example, the size of a data portion can be 64 Kbytes).

The storage control layer can be further configured to facilitate various protection schemes. By way of non-limiting example, data storage formats, such as RAID (Redundant Array of Independent Discs), can be employed to protect data from internal component failures by making copies of data and rebuilding lost or damaged data. As the likelihood for two concurrent failures increases with the growth of disk array sizes and increasing disk densities, data protection can be implemented, by way of non-limiting example, with the RAID 6 data protection scheme well known in the art.

Common to all RAID 6 protection schemes is the use of two parity data portions per several data groups (e.g. using groups of four data portions plus two parity portions in (4+2) protection scheme), the two parities being typically calculated by two different methods. Under one known approach, all N consecutive data portions are gathered to form a RAID group, to which two parity portions are associated. The members of a group as well as their parity portions are typically stored in separate drives. Under a second known approach, protection groups can be arranged as two-dimensional arrays, typically n*n, such that data portions in a given line or column of the array are stored in separate disk drives. In addition, to every row and to every column of the array a parity data portion can be associated. These parity portions are stored in such a way that the parity portion associated with a given column or row in the array resides in a disk drive where no other data portion of the same column or row also resides. Under both approaches, whenever data is written to a data portion in a group, the parity portions are also updated (e.g. using techniques based on XOR or Reed-Solomon algorithms). Whenever a data portion in a group becomes unavailable (e.g. because of disk drive general malfunction, or because of a local problem affecting the portion alone, or because of other reasons), the data can still be recovered with the help of one parity portion via appropriate known in the art techniques. Then, if a second malfunction causes data unavailability in the same drive before the first problem was repaired, data can nevertheless be recovered using the second parity portion and appropriate known in the art techniques.

The storage control layer can further comprise an Allocation Module 105, a Cache Memory 106 operable as part of the I/O flow in the system, and a Cache Control Module 107, that regulates data activity in the cache and controls destage operations.

The allocation module, the cache memory and/or the cache control module can be implemented as centralized modules operatively connected to the plurality of storage control devices or can be distributed over a part or all storage control devices.

Typically, definition of LUs and/or other objects in the storage system can involve in-advance configuring an allocation scheme and/or allocation function used to determine the location of the various data portions and their associated parity portions across the physical storage medium. Sometimes, as in the case of thin volumes or snapshots, the pre-configured allocation is only performed when a write command is directed for the first time after definition of the volume, at a certain block or data portion in it.

An alternative known approach is a log-structured storage based on an append-only sequence of data entries. Whenever the need arises to write new data, instead of finding a formerly allocated location for it on the disk, the storage system appends the data to the end of the log. Indexing the data can be accomplished in a similar way (e.g. metadata updates can be also appended to the log) or can be handled in a separate data structure (e.g. index table).

Storage devices, accordingly, can be configured to support write-in-place and/or write-out-of-place techniques. In a write-in-place technique modified data is written back to its original physical location on the disk, overwriting the older data. In contrast, a write-out-of-place technique writes (e.g. in a log form) a modified data block to a new physical location on the disk. Thus, when data is modified after being read to memory from a location on a disk, the modified data is written to a new physical location on the disk so that the previous, unmodified version of the data is retained. A non-limiting example of the write-out-of-place technique is the known write-anywhere technique, enabling writing data blocks to any available disk without prior allocation.

When receiving a write request from a host, the storage control layer defines a physical location(s) for writing the respective data (e.g. a location designated in accordance with an allocation scheme, preconfigured rules and policies stored in the allocation module or otherwise and/or location available for a log-structured storage). When receiving a read request from the host, the storage control layer defines the physical location(s) of the desired data and further processes the request accordingly. Similarly, the storage control layer issues updates to a given data object to all storage nodes which physically store data related to said data object. The storage control layer can be further operable to redirect the request/update to storage device(s) with appropriate storage location(s) irrespective of the specific storage control device receiving I/O request.

For purpose of illustration only, the operation of the storage system is described herein in terms of entire data portions. Those skilled in the art will readily appreciate that the teachings of the present invention are applicable in a similar manner to partial data portions.

Certain embodiments of the presently disclosed subject matter are applicable to the storage architecture of a computer system described with reference to FIG. 1. However, the invention is not bound by the specific architecture; equivalent and/or modified functionality can be consolidated or divided in another manner and can be implemented in any appropriate combination of software, firmware and hardware. Those versed in the art will readily appreciate that the invention is, likewise, applicable to storage architecture implemented as a virtualized storage system. In different embodiments of the presently disclosed subject matter the functional blocks and/or parts thereof can be placed in a single or in multiple geographical locations (including duplication for high-availability); operative connections between the blocks and/or within the blocks can be implemented directly (e.g. via a bus) or indirectly, including remote connection. The remote connection can be provided via Wire-line, Wireless, cable, Internet, Intranet, power, satellite or other networks and/or using any appropriate communication standard, system and/or protocol and variants or evolution thereof (as, by way of unlimited example, Ethernet, iSCSI, Fiber Channel, etc.). By way of non-limiting example, the invention can be implemented in a SAS grid storage system disclosed in U.S. patent application Ser. No. 12/544,743 filed on Aug. 20, 2009, assigned to the assignee of the present application and incorporated herein by reference in its entirety.

For purpose of illustration only, the following description is made with respect to RAID 6 architecture. Those skilled in the art will readily appreciate that the teachings of the presently disclosed subject matter are not bound by RAID 6 and are applicable in a similar manner to other RAID technology in a variety of implementations and form factors.

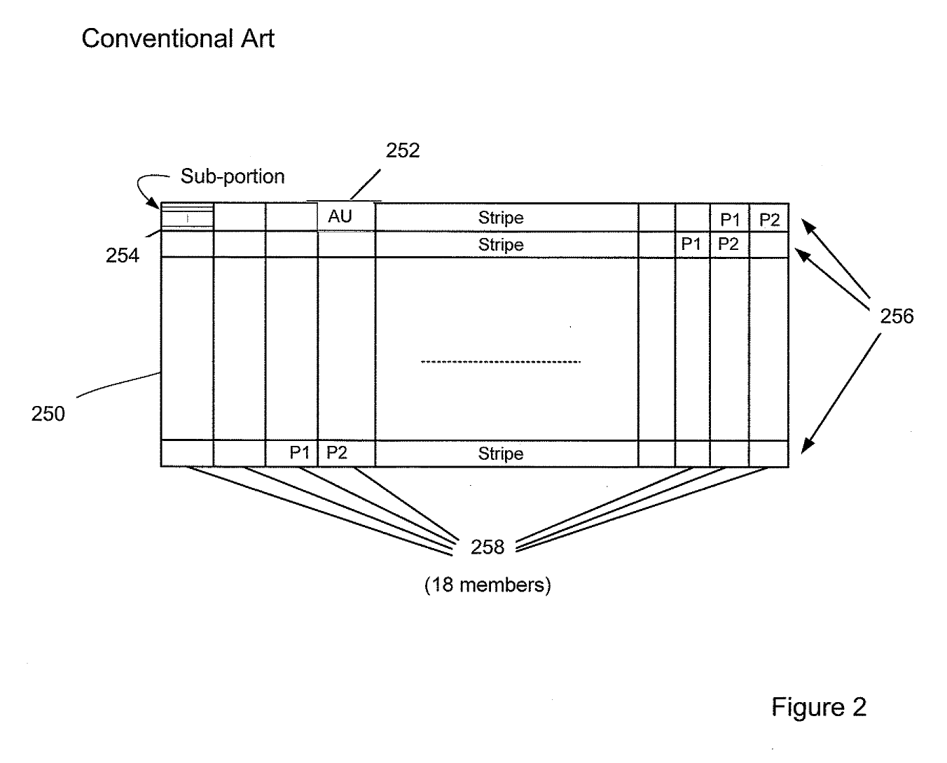

Referring to FIG. 2, there is illustrated a schematic diagram of storage space configured in RAID groups as known in the art. A RAID group (250) can be built as a concatenation of stripes (256), the stripe being a complete (connected) set of data and parity elements that are dependently related by parity computation relations. In other words, the stripe is the unit within which the RAID write and recovery algorithms are performed in the system. A stripe comprises N+2 data portions (252), the data portions being the intersection of a stripe with a member (256) of the RAID group. A typical size of the data portions is 64 KByte (or 128 blocks). Each data portion is further sub-divided into 16 sub-portions (254) each of 4 Kbyte (or 8 blocks). Data portions and sub-portions (referred to hereinafter also as “allocation units”) are used to calculate the two parity data portions associated with each stripe.

Each RG comprises M=N+2 members, MEMi (0≦i≦N+1), with N being the number of data portions per RG (e.g. N=16). The storage system is configured to allocate data (e.g. with the help of the allocation module 105) associated with the RAID groups over various physical drives. By way of non-limiting example, a typical RAID group with N=16 and with a typical size of 4 GB for each group member, comprises (4*16=) 64 GB of data. Accordingly, a typical size of the RAID group, including the parity blocks, is of (4*18=) 72 GB.

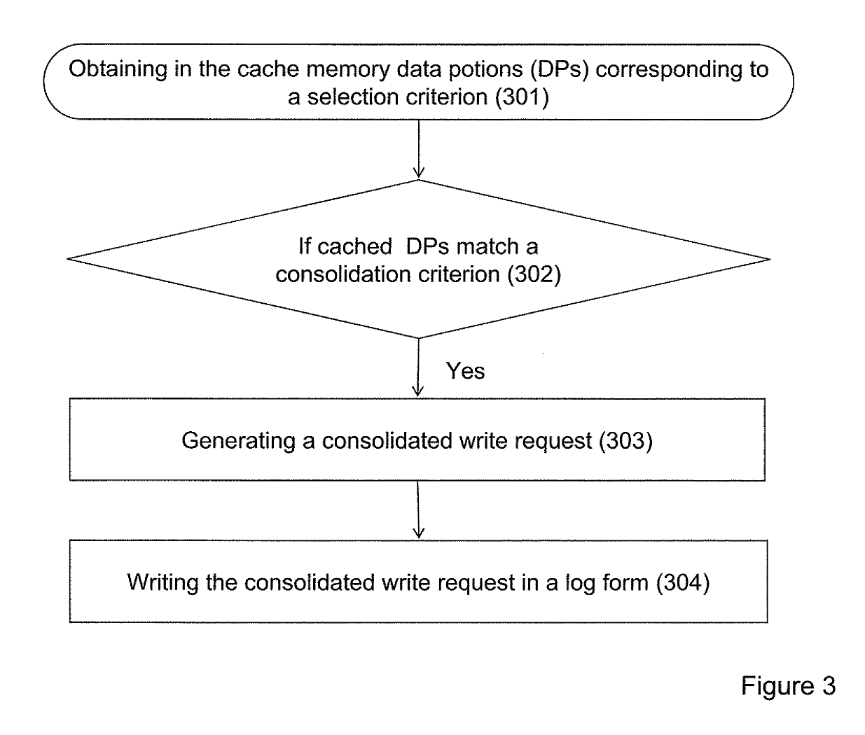

FIG. 3 illustrates a generalized flow-chart of operating the storage system in accordance with certain embodiments of the presently disclosed subject matter. The cache controller 106 (or other appropriate functional block in the control layer) analyses (302) if data portion(s) obtained (301) in the cache memory and corresponding to a selection criterion (data portions matching a selection criterion are referred to hereinafter as cached data portions) match a predefined consolidation criterion.

By way of non-limiting example, data portions matching the selection criterion can be defined as data portions selected in the cache memory and corresponding to a given write request and data portions from previous write request(s) and cached in the memory at the moment of obtaining the given write request. The data portions matching the selection criterion can further include data portions arising in the cache memory from further write request(s) received during a certain period of time after obtaining the given write request. The period of time may be pre-defined (e.g. 1 second) and/or adjusted dynamically according to certain parameters (e.g. overall workload, level of dirty data in the cache, etc.) related to the overall performance conditions in the storage system. Selection criterion can be further related to different characteristics of data portions (e.g. source of data portions and/or type of data in data portions, etc.)

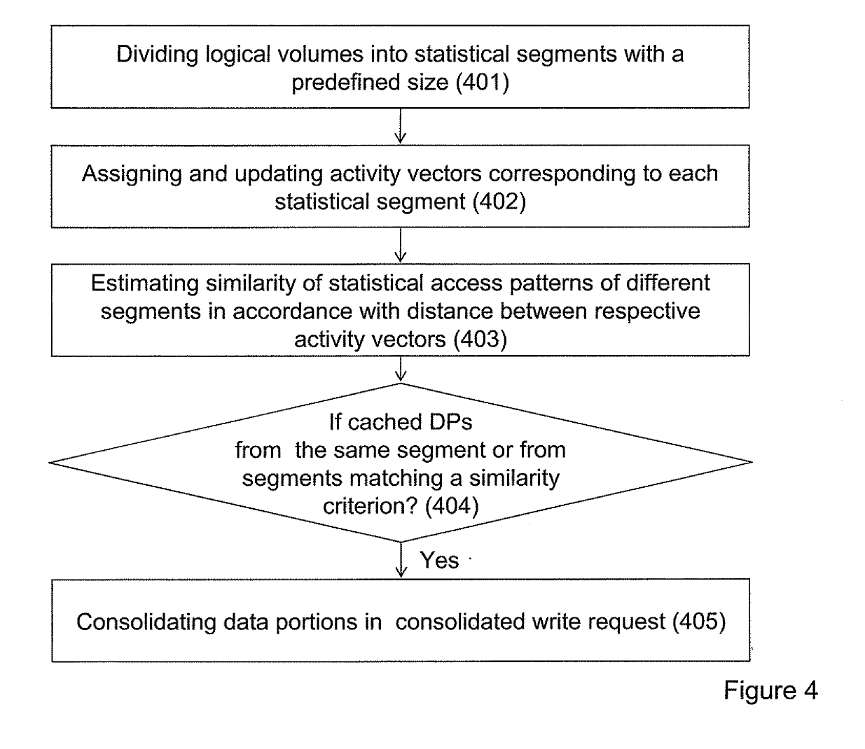

As will be further detailed with reference to FIGS. 4-7, the consolidation criterion can be related to expected I/O activities with regard to respective data portions and/or groups thereof. (I/O activities can be related to any access requests addresses to respective data portions or to selected types of access requests. By way of non-limiting example, the I/O activities can be considered merely with regard to write requests addressed to respective data portions.) Alternatively or additionally, the consolidation criterion can be related to different characteristics of data portions (e.g. source of data portions and/or type of data in data portions and/or succession of data portions with regard to addresses in the respective logical volume, and/or designated physical location, etc.).

The cache controller consolidates (303) data portions matching the consolidation criterion in a consolidated write request and enables writing (304) the consolidated write request to the disk with the help of any appropriate technique known in the art (e.g. by generating a consolidated write request built of respective data portions and writing the request in the out-of-place technique). Generating and destaging the consolidation write request can be provided responsive to a destage event. The destage event can be related to change of status of allocated disk drives (e.g. from low-powered to active status), to a runtime of caching data portions (and/or certain types of data) in the cache memory, to existence of predefined number of cached data portions matching the consolidation criteria, etc.

Likewise, if at least part of data portions among the cached data portions can constitute a group of N data portions matching the consolidation criterion, where N being the number of data portions per RG, the cache controller consolidates respective data portions in the group comprising N data portions and respective parity portions, thereby generating a destage stripe. The destage stripe is a concatenation of N cached data portions and respective parity portion(s), wherein the size of the destage stripe is equal to the size of the stripe of the RAID group. Those versed in the art will readily appreciate that data portions in the destage stripe do not necessarily constitute a group of N contiguous data portions, and can be consolidated in a virtual stripe (e.g. in accordance with teachings of U.S. patent application Ser. No. 13/008,197 filed on Jan. 18, 2011 assigned to the assignee of the present invention and incorporated herein by reference in its entirety).

FIG. 4 illustrates a generalized flow-chart of generating a consolidated write request in accordance with statistical access patterns characterizing the cached data portions and/or groups thereof.

In accordance with certain aspects of the present application, there is provided a technique for identifying data portions with similar expected I/O activity with the help of analyzing statistical access patterns related to the respective data portions. Data portions characterized by similar statistical access patterns (i.e. access patterns based on historical data) are expected to have similar I/O activity also hereinafter. Data portions with similar expected I/O activity are further consolidated in the consolidated write request (optionally, in the destage stripe).

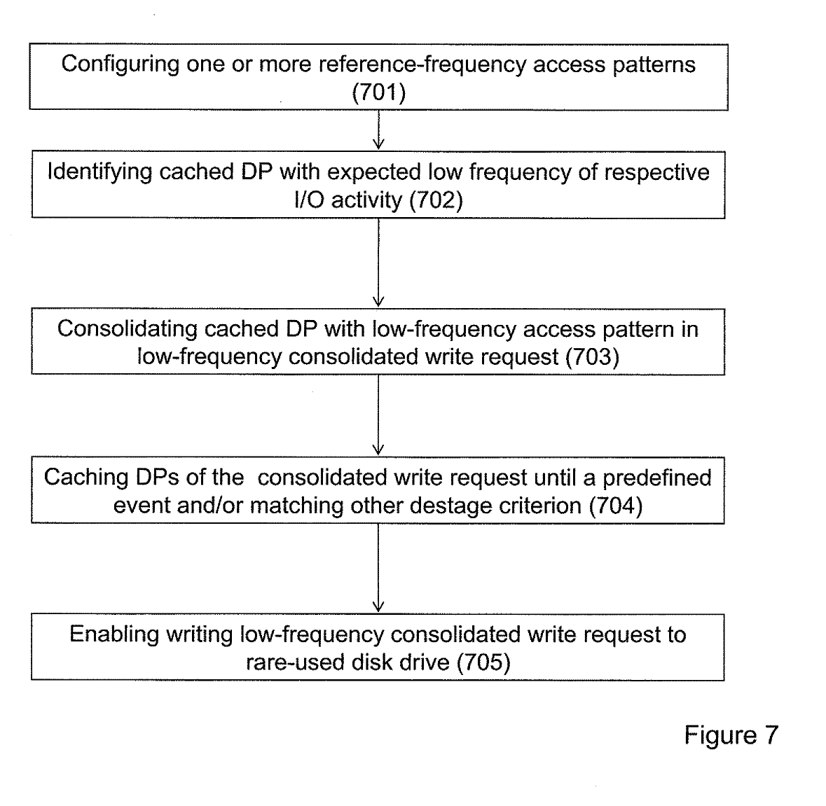

As will be further detailed with reference to FIG. 7, the consolidated write requests comprising data supposed to be frequently used can be handled in the storage system differently from write requests comprising data supposed to be rarely used. Likewise, the physical storage location can be separated in accordance with other criteria of “activity pattern” similarity. By way of non-limiting example, data portions characterized by different expected I/O activity can be stored at different disk drives thereby enabling reduced energy consumption, can be differently addressed by defragmentation and garbage collection background processes, can be differently treated during destage processes, etc. Furthermore, storing data characterized by similar statistical access patterns physically close to each other can provide, for example, performance benefits because of increasing the chances of retaining in the disk cache data that will be read together, reducing seek time in the drive head, etc.

In accordance with certain embodiments of the presently disclosed subject matter, similarity of expected I/O activity can be identified based on I/O activity statistics collected from statistical segments obtained by dividing (401) logical volumes into parts with predefined size (typically comprising a considerable amount of data portions). Data portions within a given statistical segment are characterized by the same statistical access pattern. The statistical access patterns can be characterized by respective activity vectors. The cache control module (or any other appropriate module in the control layer) assigns (402) to each statistical segment an activity vector characterizing statistics of I/O requests addressed to data portions within the segments, wherein values characterizing each activity vector are based on access requests collected over one or more Activity Periods with fixed counting length. The cache control module further updates the values characterizing the activity vectors upon each new Activity Period.

The size of the statistical segments should be small enough to account for the locality of reference, and large enough to provide a reasonable base for statistics. By way of non-limiting example, the statistical segments can be defined of size 1 GB, and the “activity vector” characterizing statistics related to each given segment can be defined of size 128 bits (8*16). All statistical segments can have equal predefined size. Alternatively, the predefined size of statistical segment can vary depending on data type prevailing in the segment or depending and/or application(s) related to the respective data, etc.

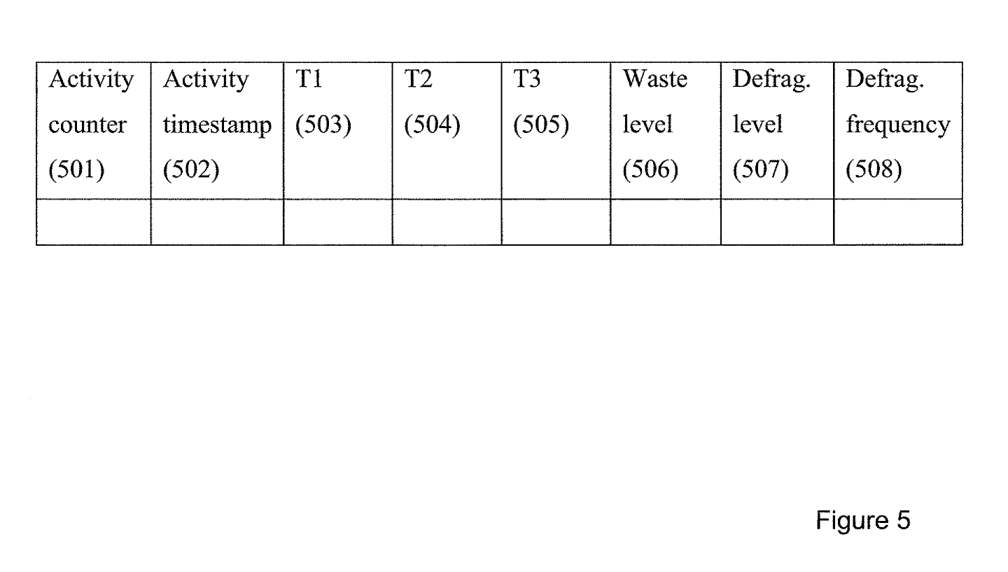

In accordance with certain embodiments of the currently presented subject matter, two or more statistical segments are considered as having similar statistical access patterns if the distance between respective activity vectors matches a predefined similarity criterion, as will be further detailed with reference to FIG. 5.

FIG. 5 illustrates a non-limiting example of an activity vector structure. The cache controller 106 (or other appropriate functional block) collects statistics from a given statistical segment with regard to a respective activity vector over activity periods with fixed counting length (e.g. 4 hours).

Within a given Activity Period, I/O activity is counted with fixed granularity intervals, i.e. all access events during the granularity interval (e.g., 1-2 minutes) are counted as a single event. Granularity intervals can be dynamically modified in the storage system, for example making it to depend on the average lifetime of an element in the cache. Access events can be related to any access request addressed to respective data portions, or to selected types of access requests (e.g. merely to write requests).

Activity Counter (501) value characterizes the number of accesses to data portions in the statistical segment in a current Activity Period. A statistical segment is considered as an active segment during a certain Activity Period if during this period the activity counter exceeds a predefined activity threshold for this period (e.g. 20 accesses). Likewise, an Activity Period is considered as an active period with regard to a certain statistical segment if during this period the activity counter exceeds a predefined activity threshold for this certain statistical segment. Those versed in the art will readily appreciate that the activity thresholds can be configured as equal for all segments and/or Activity Periods. Alternatively, the activity thresholds can differ for different segments (e.g. in accordance with data type and/or data source and/or data destination, etc. comprised in respective segments) and/or for different activity periods (e.g. depending on a system workload). The activity thresholds can be predefined and/or adjusted dynamically.

Activity Timestamp (502) value characterizes the time of the first access to any data portion in the segment within the current Activity Period or within the last previous active Activity Period if there are no accesses to the segment in the current period. Activity Timestamp is provided for granularity intervals, so that it can be stored in a 16-bit field.

Activity points-in-time values t1 (503), t2 (504), t3 (505) indicate time of first accesses within the last three active periods of the statistical segment. Number of such points-in-time is variable in accordance with the available number of fields in the activity vector and other implementation considerations.

Waste Level (506), Defragmentation Level (507) and Defragmentation Frequency (508) are optional parameters to be used for frequency-dependent defragmentation processes.

The cache controller updates the values of Activity Counter (501) and Activity Timestamp (502) in an activity vector corresponding to a segment SEG as follows: responsive to accessing a data portion DPₛ in the segment SEG at a granularity interval T,
if 0<(T−Activity Timestamp)≦counting length of Activity Period (i.e. the segment SEG has already been addressed in the present activity period), the cache controller increases the value of Activity Counter by one, while keeping the value of Activity Timestamp unchanged;
if (T−Activity Timestamp)>counting length of Activity Period, the cache controller resets the Activity Counter and starts counting for a new activity period, while T is set as a new value for Activity Timestamp.

Those versed in the art will readily appreciate that the counting length of an Activity Period characterizes the maximal time between the first and the last access requests to be counted within an Activity Period. The counting length can be less than the real duration of the Activity Period.

Before resetting the Activity Counter, the cache controller checks if the current value of the Activity Counter is more than a predefined Activity Threshold. Accordingly, if the segment has been active in the period preceding the reset, activity points-in-time values t1 (503), t2 (504) and t3 (505) are updated as follows: the value of t2 becomes the value of t3; the value of t1 becomes the value of t2; the value of t1 becomes equal to T (the updated Activity Timestamp). If the current value of Activity Counter before reset is less than the predefined Activity Threshold, values t1 (503), t2 (504), t3 (505) are kept without changes.

Thus, at any given point in time, the activity vector corresponding to a given segment characterizes:
the current level of I/O activity associated with the given segment (the value of Activity Counter);
the time (granularity interval) of the first I/O addressed at the segment in the current activity period (the value of Activity Timestamp) and in previous activity periods (values of t1, t2, t3) when the segment was active.

Optionally, the activity vector can further comprise additional statistics collected for special kinds of activity, e.g., reads, writes, sequential, random, etc.

In accordance with certain aspects of subject matter of the present application, data portions with similar statistical access patterns can be identified with the help of a “distance” function calculation based on the activity vector (e.g. values of parameters (t1, t2, t3) or (parameters Activity Timestamp, t1, t2, t3)). The distance function allows sorting any given collection of activity vectors according to proximity with each other.

The exact expression for calculating the distance function can vary from storage system to storage system and, through time, for the same storage system, depending on typical workloads in the system. By way of non-limiting example, the distance function can give greater weight to the more recent periods, characterized by values of Activity Timestamp and by t1, and less weight to the periods characterized by values t2 and t3. By way of non-limiting example, the distance between two given activity vectors V,V′ can be defined as d(V,V′)=|t1−t′|+(t2−t′2)²+(t3−t′3)².

Two segments SEG, SEG′ with activity vectors V,V′ can be defined as “having a similar statistical access pattern” if d(V,V′)<B, where B is a similarity criterion. The similarity criterion can be defined in advance and/or dynamically modified according to global activity parameters in the system.

Those skilled in the art will readily appreciate that the distance between activity vectors can be defined by various appropriate ways, some of them known in the art. By way of non-limiting example, the distance can be defined with the help of techniques developed in the field of cluster analyses, some of them disclosed in the article “Distance-based cluster analysis and measurement scales”, G. Majone, Quality and Quantity, Vol. 4 (1970), No. 1, pages 153-164.

Referring back to FIG. 4, the cache control module estimates (403) similarity of statistical access patterns of different statistical segments in accordance with a distance between respective activity vectors. The statistical segments are considered matching a similarity criterion if the calculated distance between respective activity vectors is less than a predefined similarity threshold. The cached data portions are defined as matching the consolidation criterion if they belong to the same segment or to the segments matching the similarity criterion. Optionally, the consolidation criterion can further include other requirements, besides matching the similarity criterion.

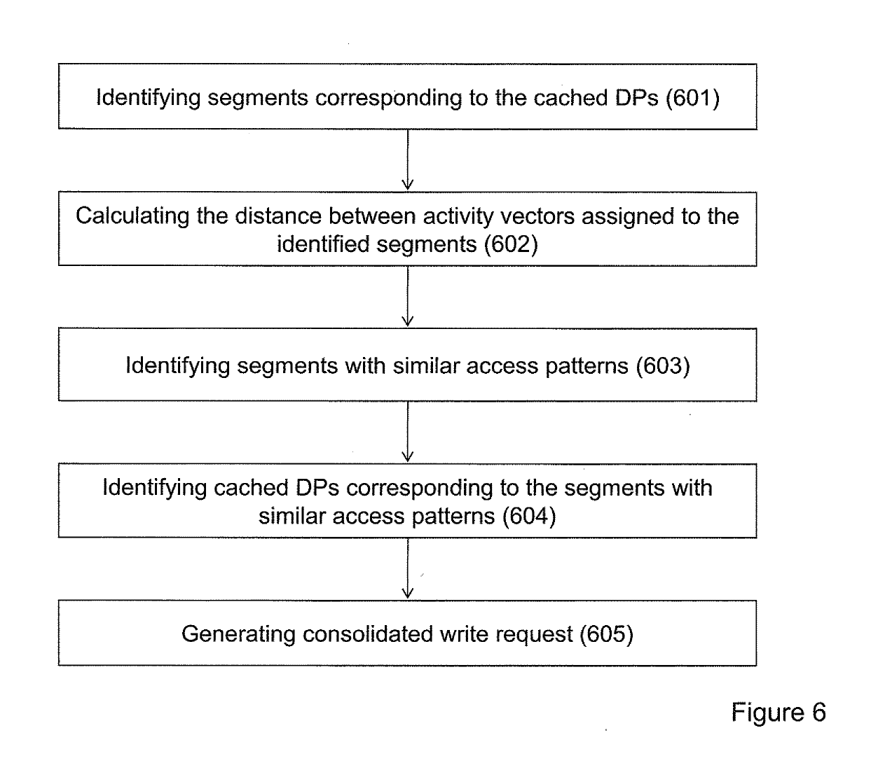

In certain embodiments of the presently disclosed subject matter, the distances can be calculated between all activity vectors, and all calculated distances can be further updated responsive to any access request. Alternatively, responsive to an access request, the distances can be calculated only for activity vectors corresponding to the cached data portions as further detailed with reference to FIG. 6.

Those versed in the art will readily appreciate that the invention is, likewise, applicable to other appropriate ways of distance calculation and updating.

The cache controller further checks (404) if there are cached data portions matching the consolidation criterion and consolidates (405) respective data portions in the consolidated write request. If at least part of data portions among the cached data portions can constitute a group of N data portions matching the consolidation criterion, the cache controller can consolidate respective data portions in the destage stripe. Optionally, data portions can be ranked in accordance with a level of similarity, and consolidation can be provided in accordance with such ranking (e.g. data portions from the same statistical segments would be preferable for consolidation in the write request).

FIG. 6 illustrates a generalized flow-chart of generating a consolidated write request responsive to an obtained write request in accordance with the currently presented subject matter, Responsive to an obtained write request, the cache control module identifies (601) segments corresponding to the cached data portions, calculates (602) the distances between activity vectors assigned to the identified segments and identifies (603) segments with similar statistical access patterns. The cache control module further identifies (604) cached data portions corresponding to the identified segments with similar access patterns, consolidates (605) respective data portions into a consolidated write request and enables writing the consolidated write request in a log form (or with the help of any appropriate technique known in the art). Generating the consolidation write request and/or writing thereof can be provided responsive to a destage event.

In accordance with certain embodiments of the presently disclosed subject matter, the cache controller identifies (702) cached data portions with expected low frequency of I/O activity. Such data portions can be identified with the help of statistical access patterns and/or activity vectors detailed with reference to FIGS. 4-6. By way of non-limiting example, the cache controller can handle configuration (701) of one or more reference-frequency access patterns (e.g. low-frequency reference access pattern and high-frequency reference access pattern). All cached data portions characterized by statistical access patterns similar to the predefined reference low-frequency access pattern are considered as data portions with expected low frequency of I/O activity. As was detailed with reference to FIGS. 3-6, the similarity of statistical access patterns can be defined in accordance with distance between respective activity vectors.

Alternatively or additionally, the cache controller can handle one or more reference-frequency activity vectors (e.g. low-frequency activity vector and high-frequency activity vector). The reference-frequency activity vector can be predefined. Alternatively, the reference-frequency activity vector can be generated in accordance with a predefined reference-frequency access pattern. Optionally, such generation can be further provided in accordance with additional factors as, for example, some statistical data used for generating activity vector corresponding to one or more cached data portions. All cached data portions characterized by activity vectors similar to the predefined reference low-frequency activity vector are considered as data portions with expected low frequency of I/O activity.

The cache controller further consolidates (703) the identified data portions with expected low frequency of I/O activity in the consolidated low-frequency write request, and handles (704) the respective data portions in the cache memory until a destage event occurs. Responsive to the destage event, the cache controller enables writing (705) the consolidated request to a disk drive configured to accommodate data portions with expected low frequency of I/O activity.

Those versed in the art will readily appreciate that in certain embodiments of the presently disclosed subject matter operations 703 and 704 can be provided in the reverse sequence, e.g. data portions with expected low frequency of I/O activity can be identified and handled in the cache memory, while further consolidated and destaged to respective disk drive(s) responsive to the destage event.

As known in the art, energy consumption in the storage system can be reduced by transitioning the disk drives to a low-powered state when they are not in use, and restoring the normal, or “active” state whenever needed. The disk drives transitioned to low-powered state can be adapted to have reduced number of revolutions per minutes (RPM) or can be turned off. Turning the disk drives off can be provided, for example, in a standby mode (when the disk does not rotate, but the electronic circuits are operable) or in idle mode (when the disk does not rotate, and the electronic circuits do not respond). Advantages and disadvantages of different low-powered state modes are well-known in the art in terms of energy saving, time to return to active state, and wear-off produced by the change in state.

In accordance with certain embodiments of the presently disclosed subject matter, one or more disk drives can be dedicated for accommodating data portions with expected low frequency of I/O activity, and can be configured to operate in low-powered state unless these disk drives are activated (e.g. by I/O request). Such activated from low-powered state disk drives can be turned back to low-powered state if no I/O requests are received during a predefined time.

Responsive to the destage event, the cache controller enables writing the low-frequency consolidated write request (i.e. the request consolidating data portions with expected low frequency of I/O activity) to the dedicated disk drives configured to operate in low-powered state. The destage event can be related to activation of low-powered disk drive (e.g. to receiving a read request addressed to data portions accommodated at such disk drive and/or receiving information indicative of active status of the dedicated disk drive, etc.). Alternatively or additionally, the destage event can be related to a runtime of caching data portions (and/or certain types of data) in the cache memory. Likewise, the cache controller identifies cached data portions with expected high frequency of I/O activity. By way of non-limiting example, all cached data portions characterized by statistical access patterns similar to a predefined reference high-frequency access pattern can be considered as data portions with expected high frequency of I/O activity. Alternatively, all cached data portions characterized by statistical access patterns non-similar to a predefined reference low-frequency access pattern can be considered as data portions with expected high frequency of I/O activity.

The cache controller further consolidates the identified data portions with expected high frequency of I/O activity in the consolidated write request and enables writing this request to a disk drive configured to accommodate frequently-used data (e.g. configured to operate in active state).

Likewise, the cached data portions can be ranked in more than two classes, each characterized by expected level of I/O activity. Cached data portions characterized by statistical access patterns similar to a reference-frequency access pattern (and/or reference activity vectors) predefined for a given class can be ranked as fitting to this given class. Write requests comprising data portions consolidated in accordance with class of expected usage are further destaged to disk drives dedicated to the respective class.

As was detailed with reference to FIGS. 3-6, the cached data portions matching a given consolidation criterion can be consolidated in destage stripes. Thus, the cached control module can be configured to generate destage stripes characterized by different expected levels of I/O activity. Accordingly, the members of a respective RAID group can be further distributed over the disk drives in a manner enabling accommodating the stripes characterized by the same expected level of I/O activity on the same disk drives. Thus, energy consumption can be reduced as certain disks will be addressed more frequently than others. For additional energy saving, disks dedicated for accommodating the stripes with low expected level of I/O activity can be further configured to operate in low-powered state.

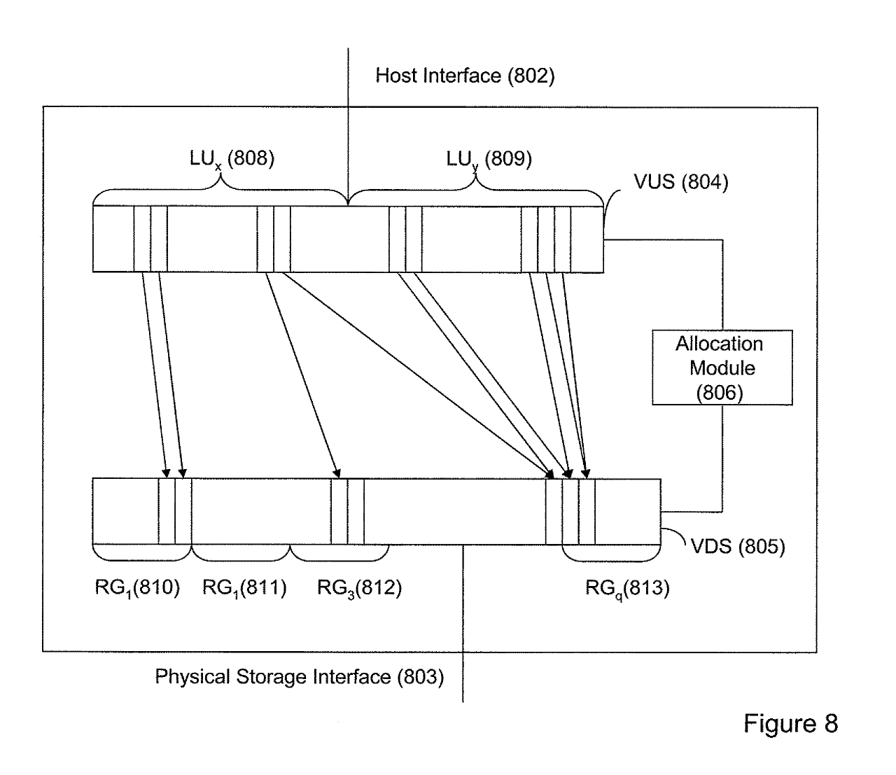

Referring to FIG. 8, there is illustrated a schematic functional diagram of a control layer configured in accordance with certain embodiments of the presently disclosed subject matter. The illustrated configuration is further detailed in U.S. patent application Ser. No. 13/008,197 filed on Jan. 18, 2011 assigned to the assignee of the present invention and incorporated herein by reference in its entirety.

The virtual presentation of the entire physical storage space can be provided through creation and management of at least two interconnected virtualization layers: a first virtual layer 804 interfacing via a host interface 802 with elements of the computer system (host computers, etc.) external to the storage system, and a second virtual layer 805 interfacing with the physical storage space via a physical storage interface 803. The first virtual layer 804 is operative to represent logical units available to clients (workstations, applications servers, etc.) and is characterized by a Virtual Unit Space (VUS). The logical units are represented in VUS as virtual data blocks characterized by virtual unit addresses (VUAs). The second virtual layer 805 is operative to represent the physical storage space available to the clients and is characterized by a Virtual Disk Space (VDS). By way of non-limiting example, storage space available for clients can be calculated as the entire physical storage space less reserved parity space and less spare storage space. The virtual data blocks are represented in VDS with the help of virtual disk addresses (VDAs). Virtual disk addresses are substantially statically mapped into addresses in the physical storage space. This mapping can be changed responsive to modifications of physical configuration of the storage system (e.g. by disk failure of disk addition). The VDS can be further configured as a concatenation of representations (illustrated as 810-813) of RAID groups.

The first virtual layer (VUS) and the second virtual layer (VDS) are interconnected, and addresses in VUS can be dynamically mapped into addresses in VDS. The translation can be provided with the help of the allocation module 806 operative to provide translation from VUA to VDA via Virtual Address Mapping. By way of non-limiting example, the Virtual Address Mapping can be provided with the help of an address trie detailed in U.S. application Ser. No. 12/897,119 filed Oct. 4, 2010, assigned to the assignee of the present application and incorporated herein by reference in its entirety.

By way of non-limiting example, FIG. 8 illustrates a part of the storage control layer corresponding to two LUs illustrated as LUx (808) and LUy (809). The LUs are mapped into the VUS. In a typical case, initially the storage system assigns to a LU contiguous addresses (VUAs) in VUS. However, existing LUs can be enlarged, reduced or deleted, and some new ones can be defined during the lifetime of the system. Accordingly, the range of contiguous data blocks associated with the LU can correspond to non-contiguous data blocks assigned in the VUS. The parameters defining the request in terms of LUs are translated into parameters defining the request in the VUAs, and parameters defining the request in terms of VUAs are further translated into parameters defining the request in the VDS in terms of VDAs and further translated into physical storage addresses.

Translating addresses of data blocks in LUs into addresses (VUAs) in VUS can be provided independently from translating addresses (VDA) in VDS into the physical storage addresses. Such translation can be provided, by way of non-limiting examples, with the help of an independently managed VUS allocation table and a VDS allocation table handled in the allocation module 806. Different blocks in VUS can be associated with one and the same block in VDS, while allocation of physical storage space can be provided only responsive to destaging respective data from the cache memory to the disks (e.g. for snapshots, thin volumes, etc.).

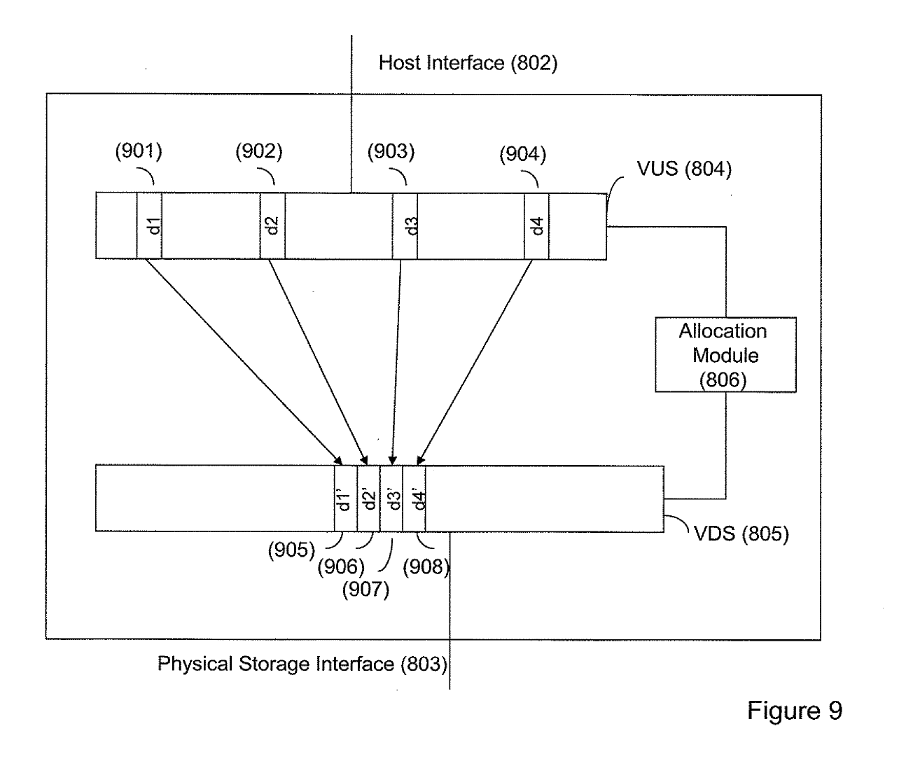

Referring to FIG. 9, there is illustrated a schematic diagram of generating a consolidated write request with the help of a control layer illustrated with reference to FIG. 8. As illustrated by way of non-limiting example in FIG. 9, non-contiguous cached data portions d1-d4 corresponding to one or more write requests are represented in VUS by non-contiguous sets of data blocks 901-904. VUA addresses of data blocks (VUA, block_count) correspond to the received write request(s) (LBA, block_count). The control layer further allocates to the data portions d1-d4 virtual disk space (VDA, block_count) by translation of VUA addresses into VDA addresses. When generating a consolidated write request (e.g. a destage stripe) comprising data portions d1-d4, VUA addresses are translated into sequential VDA addresses so that data portions become contiguously represented in VDS (905-908). When writing the consolidated write request to the disk, sequential VDA addresses are further translated into physical storage addresses. For example, in a case of the destage stripe, sequential VDA addresses are further translated into physical storage addresses of respective RAID group statically mapped to VDA. Write requests consolidated in more than one stripe can be presented in VDS as consecutive stripes of the same RG.

Likewise, the control layer illustrated with reference to FIG. 8 can enable recognition by a background (e.g. defragmentation) process non-contiguous VUA addresses of data portions, and further translating such VUA addresses into sequential VDA addresses so that data portions become contiguously represented in VDS when generating a respective consolidated write request.

By way of non-limiting example, allocation of VDA for the destage stripe can be provided with the help of a VDA allocator (not shown) comprised in the allocation block or in any other appropriate functional block.

Typically, a mass storage system comprises more than 1000 RAID groups. The VDA allocator is configured to enable writing the generated destage stripe to a RAID group matching predefined criteria. By way of non-limiting example, the criteria can be related to classes assigned to the RAID groups, each class characterized by expected level of I/O activity with regard to accommodated data.

The VDA allocator is configured to select RG matching the predefined criteria, to select the address of the next available free stripe within the selected RG and to allocate VDA addresses corresponding to this available stripe. Selection of RG for allocation of VDA can be provided responsive to generating the respective destage stripe to be written and/or as a background process performed by the VDA allocator.

Thus, when destaging data to be stored at dedicated disk drives, the VDA allocator select the address of the next available free stripe among such dedicated disk drives. If such disks are not yet activated, respective data are handled in the cache memory as long as possible. If the data need to be destaged before the allocated disks in low-powered state are activates, the VDA allocator can select the address of the next available free stripe at other disk drives in accordance with a policy implemented in the storage system. It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the present invention.

It will also be understood that the system according to the invention can be, at least partly, a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

1. A method of operating a storage system comprising a control layer configured to interface with one or more clients and to present to said clients a plurality of logical volumes, said control layer comprising a cache memory and is further operatively coupled to a physical storage space comprising a plurality of disk drives, the method comprising:
caching in the cache memory a plurality of data portions corresponding to one or more incoming write requests, to yield cached data portions;
consolidating the cached data portions characterized by a given level of expected I/O activity addressed thereto into a consolidated write request; and
responsive to a destage event, enabling writing the consolidated write request to one or more disk drives dedicated to accommodate data portions characterized by said given level of expected I/O activity addressed thereto.

2. The method of claim 1 wherein the cached data portions consolidated into the consolidated write request are characterized by expected low frequency of I/O activity, and the respective one or more dedicated disk drives are configured to operate in low-powered state unless activated.

3. The method of claim 2 wherein the destage event is related to an activation of a disk drive operating in low-powered state.

4. The method of claim 1 further comprising identifying a cached data portion as characterized by a given level of expected I/O activity if a statistical access pattern characterizing said cached data portion is similar to a predefined reference-frequency access pattern characterizing said given level of expected I/O activity.

5. The method of claim 4 further comprising collecting I/O statistics from statistical segments obtained by dividing the logical volumes into parts with predefined size, and characterizing all data portions within a given statistical segment by the same statistical access pattern defined in accordance with I/O statistic collected from the given statistical segment.

6. The method of claim 1 further comprising identifying a cached data portion as characterized by a given level of expected I/O activity if a distance between an activity vector characterizing said cached data portion and a reference-frequency activity vector characterizing said given level of expected I/O activity matches a similarity criterion.

7. The method of claim 6 further comprising collecting I/O statistics from statistical segments obtained by dividing the logical volumes into parts with predefined size, and characterizing all data portions within a given statistical segment by the same activity vector defined in accordance with I/O statistics collected from the given statistical segment.

8. The method of claim 6 wherein I/O statistics for the given statistical segment is collected over a plurality of cycles of fixed counted length, and wherein the activity vector is characterized by at least one value obtained during a current cycle and by at least one value related to I/O statistics collected during at least one of the previous cycles.

9. The method of claim 1 wherein the physical storage space further configured as a concatenation of a plurality of RAID Groups, each RAID group comprising N+P RAID group members, and wherein the consolidated write request comprises N cached data portions characterized by a given level of expected I/O activity and P respective parity portions, thereby constituting a destage stripe corresponding to a RAID group.

10. The method of claim 9 wherein the members of a RAID group are distributed over the disk drives in a manner enabling accommodating the destage stripes characterized by the same level of expected I/O activity on one or more disk drives dedicated to accommodate destage stripes characterized by said given level of expected I/O activity.

11. The method of claim 10 wherein the cached data portions consolidated into the destage stripe are characterized by expected low frequency of I/O activity, and the respective one or more dedicated disk drives are configured to operate in low-powered state unless activated.

12. A storage system comprising a physical storage space comprising a plurality of disk drives and operatively coupled to a control layer configured to interface with one or more clients and to present to said clients a plurality of logical volumes,
wherein one or more disk drives are configured as dedicated to accommodate data portions characterized by a given level of expected I/O activity, and
wherein said control layer comprises a cache memory and further operable:
to cache in the cache memory a plurality of data portions corresponding to one or more incoming write requests, to yield cached data portions;
to consolidate the cached data portions characterized by said given level of expected I/O activity addressed thereto into a consolidated write request; and
responsive to a destage event, to enable writing the consolidated write request to said one or more disk drives dedicated to accommodate data portions characterized by said given level of expected I/O activity.

13. The storage system of claim 12 wherein the cached data portions consolidated into the consolidated write request are characterized by expected low frequency of I/O activity, and said one or more dedicated disk drives are configured to operate in low-powered state unless activated.

14. The storage system of claim 13 wherein the destage event is related to an activation of a disk drive among the dedicated disk drives and configured to operate in low-powered state.

15. The storage system of claim 12 wherein the control layer is further operable to identify a cached data portion characterized by a given level of expected I/O activity in accordance with similarity between a statistical access pattern characterizing said cached data portion and a predefined reference-frequency access pattern characterizing said given level of expected I/O activity.

16. The storage system of claim 15 wherein the control layer is further operable to collect I/O statistics from statistical segments obtained by dividing the logical volumes into parts with predefined size, wherein all data portions within a given statistical segment are characterized by the same statistical access pattern defined in accordance with I/O statistic collected from the given statistical segment.

17. The storage system of claim 12 wherein the control layer further operable to identify a cached data portion characterized by a given level of expected I/O activity in accordance with a distance between an activity vector characterizing said cached data portion and a reference-frequency activity vector characterizing said given level of expected I/O activity.

18. The storage system of claim 17 wherein the control layer is further operable to collect I/O statistics from statistical segments obtained by dividing the logical volumes into parts with predefined size, wherein all data portions within a given statistical segment are characterized by the same activity vector defined in accordance with I/O statistic collected from the given statistical segment.

19. The storage system of claim 12 wherein the physical storage space further configured as a concatenation of a plurality of RAID Groups, each RAID group comprising N+P RAID group members, and wherein the consolidated write request comprises N cached data portions characterized by a given level of expected I/O activity and P respective parity portions, thereby constituting a destage stripe corresponding to a RAID group.

20. The storage system of claim 19 wherein the members of a RAID group are distributed over the disk drives in a manner enabling accommodating the destage stripes characterized by the same level of expected I/O activity on one or more disk drives dedicated to accommodate destage stripes characterized by said given level of expected I/O activity.

21. The storage system of claim 20 wherein the cached data portions consolidated into the destage stripe are characterized by expected low frequency of I/O activity, and the respective one or more dedicated disk drives are configured to operate in low-powered state unless activated.

22. The storage system of claim 21 wherein the control layer further comprises a first virtual layer operable to represent the cached data portions with the help of virtual unit addresses corresponding to respective logical addresses, and a second virtual layer operable to represent the cached data portions with the help of virtual disk addresses (VDAs) substantially statically mapped into addresses in the physical storage space, and wherein:
the second virtual layer is configured as a concatenation of representations of the RAID groups;
the control layer is operable to generate the destage stripe with the help of translating virtual unit addresses characterizing data portions in the stripe into sequential virtual disk addresses, so that the data portions in the destage stripe become contiguously represented in the second virtual layer; and
the control layer is further operable to translate the sequential virtual disk addresses into physical storage addresses of the respective RAID group statically mapped to second virtual layer, thereby enabling writing the destage stripe to one or more dedicated disk drives.

23. The storage system of claim 22 wherein the control layer further comprises a VDA allocator configured to select a RAID Group matching a predefined criteria; to select the address of the next available free stripe within the selected RAID Group; and to allocate VDA addresses corresponding to this available stripe.

24. A non-transitory computer readable medium storing a computer readable program executable by a computer for causing the computer to perform a process of operating a storage system comprising a control layer configured to interface with one or more clients and to present to said clients a plurality of logical volumes, said control layer comprising a cache memory and is further operatively coupled to a physical storage space comprising a plurality of disk drives, the process comprising:
caching in the cache memory a plurality of data portions corresponding to one or more incoming write requests, to yield cached data portions;
consolidating the cached data portions characterized by a given level of expected I/O activity addressed thereto into a consolidated write request; and
responsive to a destage event, enabling writing the consolidated write request to one or more disk drives dedicated to accommodate data portions characterized by said given level of expected I/O activity addressed thereto.

25. A computer program product comprising a non-transitory computer readable medium storing computer readable program code for a computer operating a storage system comprising a control layer configured to interface with one or more clients and to present to said clients a plurality of logical volumes, said control layer comprising a cache memory and is further operatively coupled to a physical storage space comprising a plurality of disk drives, the computer program product comprising:
computer readable program code for causing the computer to cache in the cache memory a plurality of data portions corresponding to one or more incoming write requests, to yield cached data portions;
computer readable program code for causing the computer to consolidate the cached data portions characterized by a given level of expected I/O activity addressed thereto into a consolidated write request; and
computer readable program code for causing the computer to, responsive to a destage event, enable writing the consolidated write request to one or more disk drives dedicated to accommodate data portions characterized by said given level of expected I/O activity addressed thereto.
